(19) United States
(12) Patent Application Publication
(10) Pub. No.: US 2003/0063071 A1
(43) Pub. Date: Apr. 3, 2003

(54) Method and apparatus for signaling user initiated hot-key switch control

(76) Inventor: David A. Wyatt, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/966,519

(22) Filed: Sep. 28, 2001

(51) Int. Cl. G09G 5/00

(52) U.S. Cl. 345/172

(57) ABSTRACT

A co-operative firmware and driver-based mechanism in which a device driver obtains control to perform and complete some action which was initiated by a system hot-key.

### FIELD OF THE INVENTION

The present invention relates to the field of processors, mobile computers and, more particularly, to a technique to process hot-key switch control actions.

### BACKGROUND OF THE RELATED ART

An integrated or embedded controller may support a plurality of related functions which are selected by a use of a hot-key or a sequence of keys, which when actuated will change modes between/among the functions. For example, in a graphics controller supporting a plurality of possible display outputs, a display change may be initiated by an actuation of a key (or sequence of key strokes), generally referred to as hotkey. Accordingly, the controller may be designed to operate with a mobile notebook computer or a desktop computer system, by having the controller support different types of display outputs, such as an internal digital flat panel display or an external display monitors. Alternatively, a controller in a notebook computer may support both a flat panel display, as well as an external monitor. A hot-key may be selected, which when depressed, will switch the active screen and the video contents between the various supported displays.

Hot-Keys are commonly used to toggle between Display Panel-Fitting (image is stretch/shrunk to fit the screen) and centering (image is located in the center of the screen). This event and the information is useful to the driver which may need to adjust positional information and image or sprite scaling factors. Hot-Keys are also used to control Display Panel Brightness and Contrast. It would be advantageous to have a means to ensure backlight control to pass through the display driver, which is important if the Backlight Brightness is being controlled dynamically by the Driver or the Operating System. Hot-Keys are also used to adjust Audio Output Volume Level. Communicating this through the driver would allow consistency between volume settings created through the Graphical User Interface and changes initiated through the Hot-Keys.

One of the more common methods for supporting hot-key actions (such as Display Switch, Brightness Control, Panel Fitting, Audio Volume or other Hot-Key) relies on performing the switching function entirely within a particular system mode, such as the system management mode (SMM) of a computer system. The hot-key action is captured typically in a keyboard controller or in an embedded controller to place the system into the SMM when the hot-key action is detected. In a typical computer operation, when the processor, for example a central processing unit (CPU), is placed in the SMM, the operating system (O/S) and the running applications are stalled while the hot-key action is handled. The action usually results in the video's Basic Input Output System (BIOS) program being called through its interface. The video BIOS then performs the control action (e.g. Display Switching, Brightness Control, Panel Fitting, Audio Volume or other Hot-Key) and returns control to the video controller or the processor. Upon exiting the system management mode the processor context is restored and execution then continues with the new display output.

However, the current hot-key technique has a number of limitations. Some of these limitations include (but are not limited to) the following. The system management mode is a highly restricted mode which places the O/S and the applications program in a standby state, while the video BIOS performs its handling of the hot-key event. The hot-key action is typically discovered by polling or by use of an event timer, which requires repeated checking for an occurrence of a hot-key event. Accordingly, user-perceptible delay may occur or potential artifacts may result. Since the video BIOS is performing the switching function, the video BIOS typically will need to have full knowledge of all display related configuration aspects of the controller. However, it may be difficult to retain new information in the video BIOS as system configurations and drivers change. Also, by performing changes apart from the video driver and/or the user interface, other limitations may be introduced which can impact the stability of the system indirectly. Furthermore, some programs which impact the display may be disabled while the SMM is being processed. For example, the video overlay function of the display controller may be disregarded since overlay software resides outside of the scope of the SMM, therefore if actions performed within SMM affect video overlay through changes to the display configuration, that effect will go unnoticed. Where user interface actions may be offered, incorrect or contradictory options may be selected by the user, leading to destabilization or possibly actual damage of the display.

The present invention provides for a scheme in which hot-key switch actions can be performed outside of the system management mode, with the inherent benefits of persistent control from within the very software components that have full knowledge of the complex interactions and side effects of the control actions.

### BRIEF DESCRIPTION OF THE DRAWINGS

FIG. 1 shows a block schematic diagram showing one implementation of the invention.

FIG. 2 shows an operational implementation of the invention.

FIG. 3 shows a process flow diagram for an embodiment of the invention.

FIG. 4 shows a flow diagram for implementing two schemes for handling a hotkey event.

FIG. 5 shows another process flow diagram for an embodiment of the invention.

FIG. 6 shows still another process flow diagram for an embodiment of the invention.

FIG. 7 shows a system level diagram incorporating an embodiment of the invention.

### DETAILED DESCRIPTION OF THE INVENTION

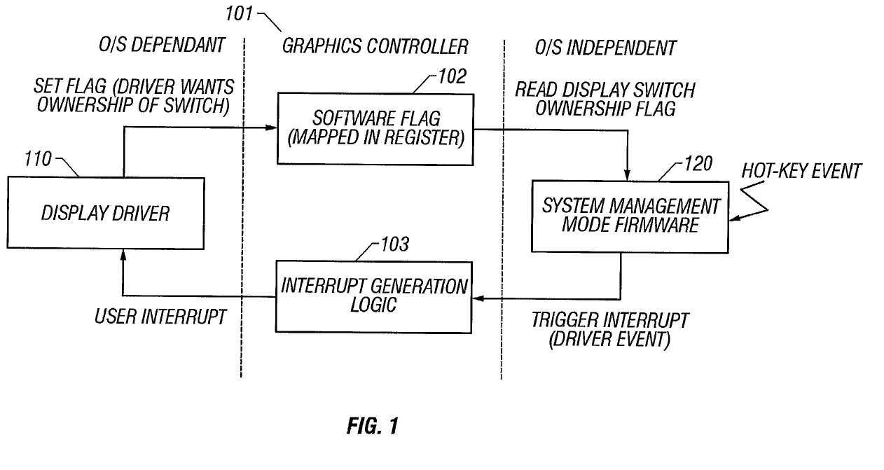

Referring to FIG. 1, an apparatus embodying the present invention is shown. The apparatus illustrated in FIG. 1 comprises a processor, such as, for example, a graphics controller 101, which may include a register (or registers) 102 to map a software flag or flags. The example apparatus also comprises an interrupt generation logic 103 to handle interrupt triggers generated by a system firmware. Coupled to the graphics controller 101 is a display driver 110. The display driver 110 is typically a software program, which is operationally dependent on the operating system (O/S) software. The display driver 110 operates in conjunction with the operating system and the graphics controller 101 to provide the programming to drive a display unit. Operating independent of the operating system is firmware 120. The firmware 120 handles a management mode for a computer, which in this example is referred to as a system management mode (SMM). When activated, the apparatus enters the SMM and generally operates independent of the O/S. Generally, SMM is a special execution mode of a processor to manage the system. Also, although the term controller (specifically referred to as graphics controller) is utilized herein, a more generic term that may be applied is processor. That is, the controller is a processing or controlling device, so that a variety of processors can be readily used herein where the controller is mentioned.

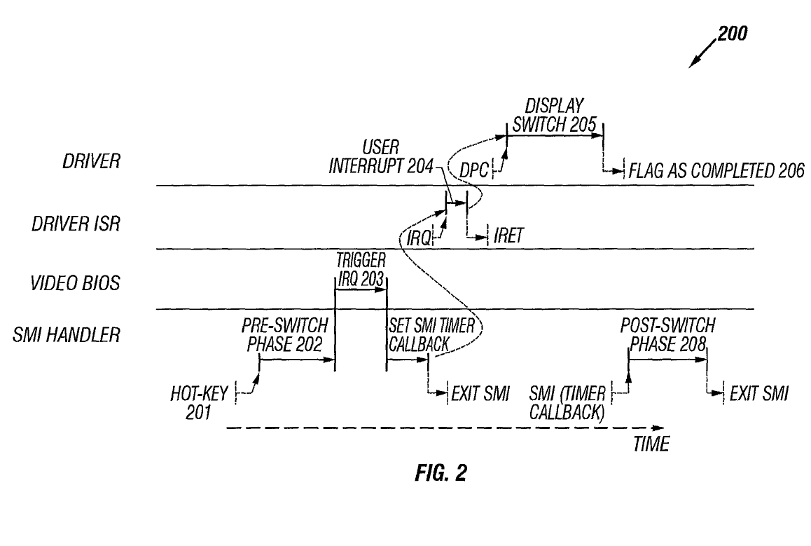

In the shown example of FIG. 1, the system management mode firmware 120 responds to an occurrence of a hot-key event by generating a trigger to the interrupt generation logic 103. That is, the hot-key event initiates an interrupt trigger as a driver event and the interrupt generation logic 103 of the graphics controller 101 generates an interrupt in response to the trigger. The hot-key trigger results in the interrupt generation logic 103 to generate a user interrupt to the driver 110, which then results in the driver 110 obtaining ownership of a hot-key control action (e.g. such as display switch, brightness control, panel fitting, audio volume or other Hot-Key) through a software flag of unit 102. That is, the appropriate driver 110 performs indicates it requires control of the control action instead of default SMM and Video BIOS path. Accordingly, the display switching initialed by a hot-key event is handled by the display driver 110, instead strictly by the video BIOS in the system management mode. One embodiment to perform the functionality of the apparatus shown in FIG. 1 is further illustrated in FIG. 2.

Referring to FIG. 2, a diagram 200 illustrating a functional operation of an embodiment of the invention is shown. In the particular example of FIG. 2, a hot-key (or sequence of keys) event 201, when initiated, performs a display switch action to switch the video to a different display unit. A system management interrupt (SMI) handler, which may typically be part of the system management mode firmware (for example, the SMM firmware 120 shown in FIG. 1), initiates a pre-switch phase 202 in response to the hot-key event. The SMI handler then causes the video BIOS to trigger a request for an interrupt, which is shown as a trigger 203 in FIG. 2. The example noted is a software trigger for an interrupt request (IRQ) signal associated with an input/output (I/O) operation of a computer system. The interrupt request trigger signal is then sent to an interrupt handler of the controller (or the processor). In the example shown in FIG. 1, the event triggers a generation of an interrupt from the interrupt generation logic 103 of the controller 101.

Subsequently, once the SMI handler triggers an interrupt request, the SMI handler sets a SMI timer callback and exits the system management mode. In one application, the SMI timer callback uses a set time duration for the callback. Upon exiting the SMM, the operating system and/or the application software, which may have been placed on hold during the interrupt handling sequence of the SMI handler, may now continue performing program functions. This release of the processor usage is shown in FIG. 2 as an exit from the SMI. However, the callback timer will allow the controller (or processor) to return to the SMI handler once again to conclude the initiated operation.

Though the controller is now no longer in the system management mode, the interrupt generation logic generates a user interrupt to an interrupt service routine (ISR). In the shown example, the ISR recognizes that this particular interrupt is associated with the display driver (such as, for example, the display driver 110 of FIG. 1). A user interrupt request (IRQ) 204 relating to the video driver is handled by the driver ISR, which results in the driver responding to the user interrupt 204 with an indication that the driver wants ownership of the control action. In the example shown, a flag is set to indicate that the driver wants ownership of the action to effect a display switch, brightness control, panel fitting, audio volume or other Hot-Key action 205. When the driver ownership flag is noted by the controller, the controller will permit the driver to obtain control of the display. For example, at this point, the controller may decouple the video from the first display.

When the controller is ready, the controller will allow the driver to obtain ownership of the display. The driver then performs the program changes (shown as display switch 205) for the second display. Once the driver has performed the control action 205, the driver sets a flag 206 to indicate that the action 205 has been completed. It is to be noted at this point the driver has now performed a software process to support the action and has indicated the completion of the software control by the flag 206.

In the meantime, the operating system may continue to execute O/S and application programs, independent of the driver switch actions. However, the SMI handler continues to generate timer callback(s) in order to determine if the display switching has been performed by the driver software. The timer callback may be initiated at pre-selected times or set for other timers or events.

In the particular embodiment shown in FIG. 2, the SMI handler returns to check for the state of flag 206 to monitor switch display completion. As noted, the call back to monitor the flag 206 may be set at arbitrary times or at periodic times to determine the state of the flag 206. If during one of the call backs, the flag interrogation indicates that the driver has completed the display switch 205, then the SMI handler enters a post-switch phase 208 to allow the controller to switch in the now designated display unit. If the flag interrogation indicates that the driver has not completed the switch 205, then the SMI handler exits the post-switch phase and returns to it again at the next callback period. It is appreciated that a variety of adaptations may be implemented for the particular embodiment shown in the diagram of FIG. 2, to perform the display switching according to various embodiments of the invention. Thus, the display switching example need not be limited to the particular embodiment illustrated in FIG. 2. For example, rather than setting a flag and relying on SMI callback, the driver may signal completion at the end of processing the control action by performing a call into video BIOS and/or system BIOS which itself causes re-entry into SMM and thereby is used to signal completion of the hotkey action to the SMM hot-key management software.

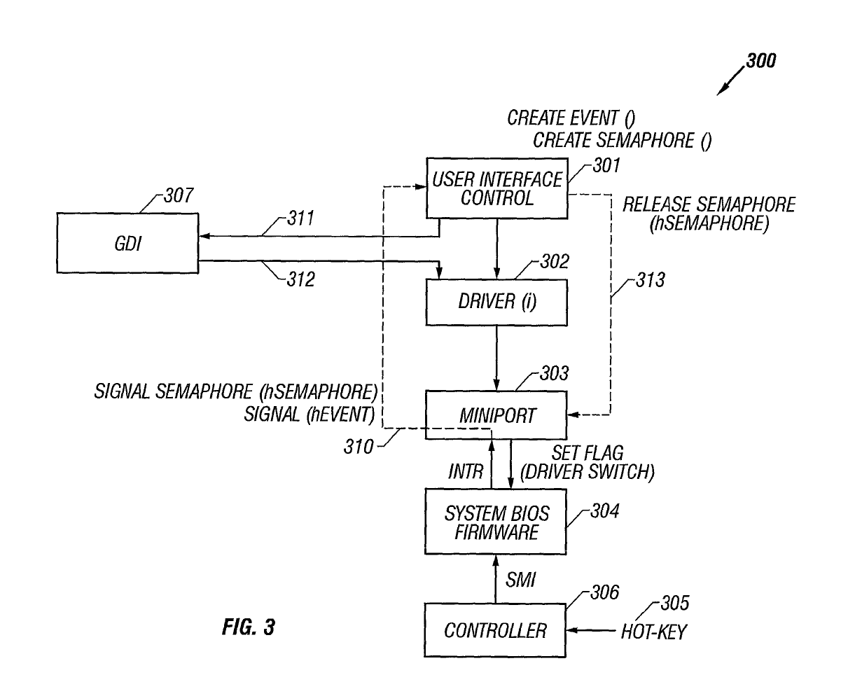

The functional aspects of the diagram of FIG. 2 may be implemented in a variety of ways. Software routines are typically included in the driver to perform the various program functions described herein. Furthermore, flags/semaphores may be stored in a variety of locations, including registers located in the controller, as noted in FIG. 1. FIG. 3 shows an embodiment 300, in which various components are initialized and made operative for hot-key action. In the example, an user interface control manager 301 creates an event and semaphore handles, which are passed to a display driver 302. The event and semaphore handles are also provided to a hardware interface, shown as a miniport 303. The miniport 303 recognizes that the infrastructure is in place to support the display driver switching. It will then set some indication to indicate that driver switching is to be used. In the particular embodiment, a flag is set to indicate that driver control of the display switching is desired. The flag setting is communicated to the system BIOS firmware 304.

At some later time, when the user depresses the platform specific hot-key 305 (or sequence of keys), a graphics controller 306 will then enter the system management mode by triggering the SMI signal. The SMI handler code within the system BIOS will recognize the SMI is for a hot-key and will perform the pre-switch management as part of the pre-switch phase. For example, the system BIOS may disable the touch pad or the back light control, etc. and then call the video BIOS. The video BIOS will detect the flag set to determine if the display driver is to be initiated to control the display switching. It will then access the graphics controller's interrupt generation logic, which may include interrupt registers, and trigger a user interrupt while still in the system management mode. In the particular embodiment the user interrupt may be a software triggered Peripheral Components Interconnect (PCI) interrupt, which is placed onto the interrupt line owned by the graphics controller.

The interrupt service routine inside the miniport 303 receives the interrupt and discerns from the other flag bits that this is a user interrupt for a display switch. The miniport will check if another process is holding the semaphore, which would imply that a display switch is already in progress and therefore the hot-key will not be processed. If the semaphore is not held either in the driver ISR, or in another worker thread, such as an Asynchronous or Deferred Procedure Call, the driver 303 will signal an event (shown by dotted line 310) to the user interface control manager 301 using the event and semaphore handles noted above.

The user interface control manager 301 then receives the event in a program, for example a waiting worker thread, and initiates the process of switching displays. In the particular embodiments shown, display settings are enumerated through a call operation (shown by line 311) to a Graphical Display Interface (GDI) 307. The operating system translates this call operation, which then request display driver to enumerate the supported display resolutions for a particular display device (which action is shown by line 312). This procedure allows the display driver an opportunity to understand and to be prepared for the display being switch in. The user interface control manager 301 receives the list of supported display modes and having already understood the next display, sends a signal to the GDI 307 to perform the display switch (also shown by line 311). The new display mode is set by a signal (also shown by line 312) to the driver 302. The display driver 302 and the miniport 303 will then initiate the display setting. Once the user interface control manager 301 completes the display switching and reconfigures the interface it will then release the semaphore (shown by line 313) allowing for the next hot-key event to be performed. In one embodiment, a handled flag is set (similar to flag 206 in FIG. 2) to identify a completion state.

The SMI timer callback described above in reference to FIGS. 1 and 2, is implemented as well in the technique diagramed in FIG. 3. The SMI timer callback causes the SMI handler to be re-entered at a later time. Thus, after the display switch action is initiated, the system BIOS 304 will initiate the driver-based switching and exit the SMM. Then, periodically the system BIOS firmware 304 re-enters during timer callback to check on the status of the handled flag. If this flag indicates a non-handled state, then another callback is scheduled). If this flag indicates a handled state, then the SMI handler enters and performs activity of the post-switch phase.

It is appreciated that other embodiments may be implemented to perform the display switching operation. For example, a variation of the above method may be implemented without sending events to the user interface control program of the control 301. In one embodiment, the display driver performs the switch itself. In this instance, since the display driver performs the switching, the driver may need to retain the expected resolution during the switch. Other schemes may be readily implemented to perform the display switching outside of the SMM.

In an alternative embodiment, the technique described above is combined with a separate technique in which the video BIOS controls the display switching. In this alternative technique, the scheme described above is combined to operate with a mode in which the video BIOS provides the display switching function. When only the video BIOS is invoked, the pre-switch phase of the SMI handler calls the video BIOS. Instead of triggering an interrupt as was noted above, the video BIOS provides the display switching and returns control to the SMI handler. Accordingly in one alternative embodiment of the invention, both of the techniques are implemented and available, but only one is selected for use.

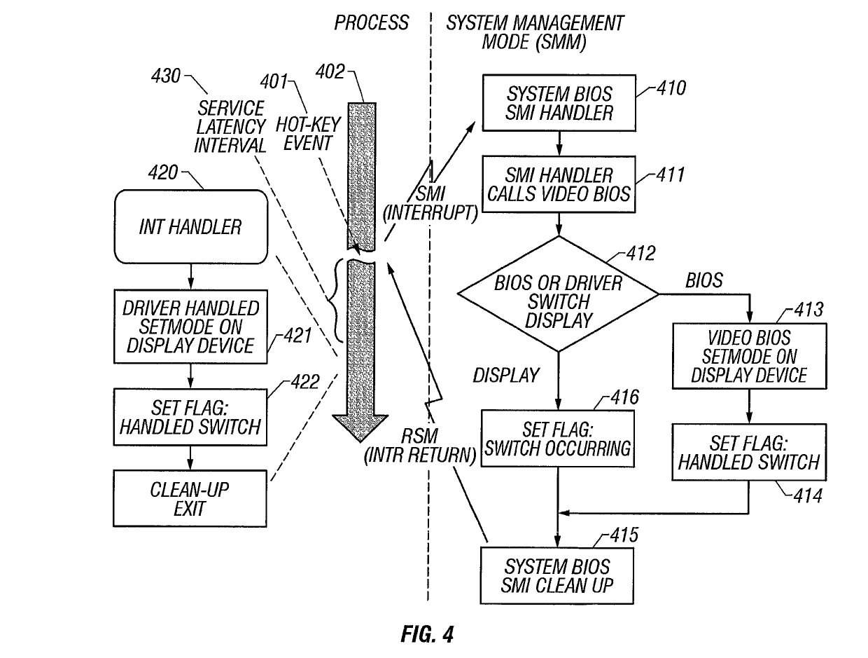

Referring to FIG. 4 an example flow diagram is shown in which the controller retains the system management mode to perform the video BIOS-based display switching or invokes the driver-based display switching external to the SMM. In the diagram 400 of FIG. 4 a hot-key event 401 is shown occurring while the graphics controller is in operation. The controller operation flow is shown by arrow 402. As noted previously, the controller is initially programmed to handle the driver-based display switching. The controller also can allow the video BIOS to handle the display switching through the SMM. Some mechanism is used to establish which of the two schemes will be used to handle the display switching interrupt. In one example, a display switch flag is used. The SMM-based switching is selected as the default. In this manner, a display not supported by the driver-based switching will use the SMM mode switching to effect the display switch.

When the hot-key event 401 occurs, the O/S enters the SMM and invokes the SMI handler of the System BIOS, as shown by block 410. The SMI handler then calls the video BIOS, as shown by block 411. A mechanism, such as the above-mentioned flag identifies if control of the action will reside in Firmware (such as the video BIOS) or if driver-based control will be utilized (shown by block 412). In the display switch example if the video BIOS is to handle the switching, the CPU context stays within the SMM context and subseqnently the video BIOS would be called to handle the switch, as shown by block 413. Then, the switch handled flag is set (as shown in block 414) and the SMI clean up is completed by the system BIOS (as shown in block 415). The controller exits the SMM and returns to the process 402, which was suspended during SMM. Since this method is not signaled with an event to other software the switch handled flag may be recognized by driver software at some indeterminate time later.

In the embodiment of FIG. 4, the SMM could have invoked the driver-based switching, if the flag in the decision block 412 had indicated the driver-based switching is supported. If the flag or the semaphore is set to invoke the driver-based switching, then the SMM will set a display switch occurring flag (as shown in block 416 and progress to the clean up of block 415. The O/S exits the SMM and proceeds with the process 402. However, a callback scheme (for example a callback timer) is activated to return to the SMI handler to check on the status of the handled switch flag, as was described with completion flag 206 in FIG. 2. The interrupt handler 420 initiates the driver ISR to handle the display switch (as shown by block 421). The driver-based display switch is effected by the driver and the handled switch flag is set, as shown by block 422. During the post-switch phase, the clean up is achieved, and the system is returned back again to the continuing process 402. The driver-based display switching is achieved, for example, by the technique described in reference to FIG. 2.

Therefore, in the alternative embodiment described in reference to FIG. 4, a particular graphics controller can be designed to provide both the system management mode-based handling of the display switching or the display-based switching provided by the display driver. The selection as to which of the two processes to choose can be varied, depending on the system configuration of the controller, processor or the O/S. In some instances the selection is designed into the system without user input and in other instances the selection can be made available to the user through user programming. Furthermore, it is to be noted that a service latency period 430 occurs with the driver-based switching. During this time, the process 402 can continue to operate, since the controller is not in the SMM mode.

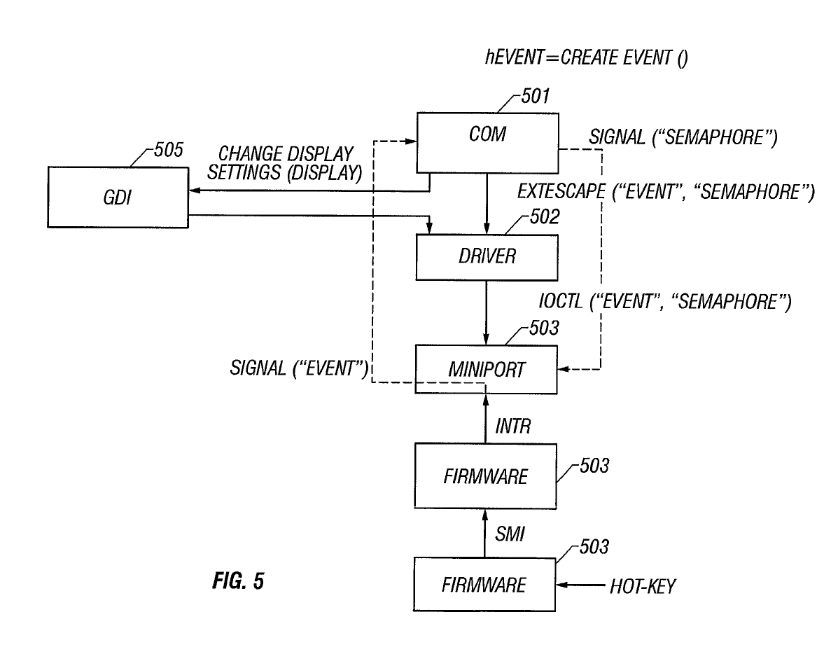

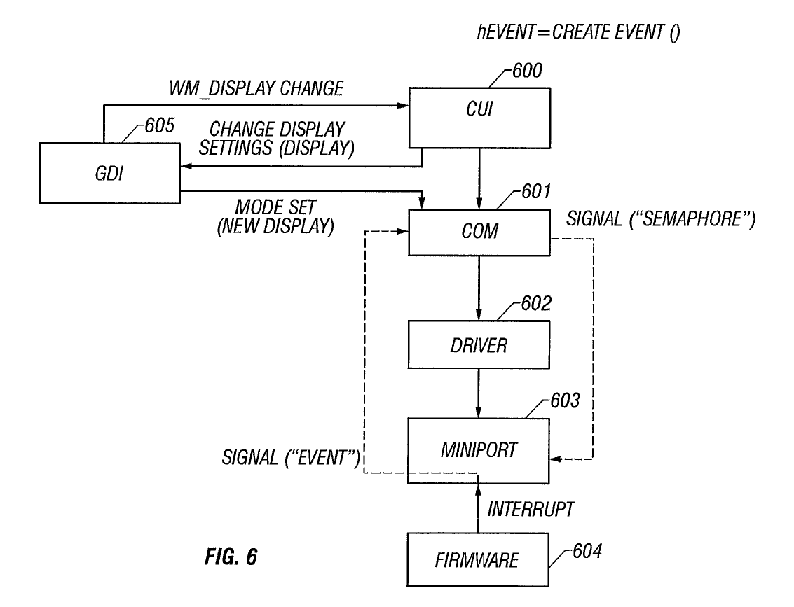

An alternative example application for an embodiment of the invention is illustrated in the reference to FIGS. 5 and 6. FIG. 5 exemplifies an event synchronization mechanism to handle the hot-key event. At the upper-level, the user interface (such as the command layer of the control panel user interface, as shown by block 501) registers the change in the active display device and, if necessary, alter the options available or register the current correct display. The application layer monitors for the change by initializing a create event set up for a video driver 502 and resetting the event to the known state. At the driver level the driver creates a semaphore or flag, which is typically done during driver initialization. The driver clears the semaphore and is ready to handle interrupts which it receives. Whenever an event is received by a firmware 503 and it is being processed by the driver, this semaphore identifies that an event is currently being serviced. Code is then executed to initiate the display switch at which point the semaphore is cleared indicating that the event has been handled by the application. A miniport 504 and GDI 505 operate equivalent to like identified items in FIG. 3. One example software routine for providing the above in utilizing programming threads is shown below.

DWORD cbRet;

OVERLAPPED overlapped;

BOOL bRet;

memset(&overlapped, 0, sizeof (OVERLAPPED));

overlapped.hevent=Create Event (NULL, FALSE, FALSE, NULL);

bRet=DeviceloControl (Device Handle, (DWORD) IOCTL_REGISTER_CALLBACK, NULL, 0, NULL, 0, &cbRet, &overlapped);

if(bRet==TRUE)

WaitforSingleObject(overlapped.hEvent, INFINITE); ul=//SET_TO_LFP,SET_TO_DFP, SET_TO_CRT or SET_TO_TV ExtEscape(hDC, ESC_SET_DISPLAY, sizedof(ul), &ul, 0, 0); ChangeDisplaySettings(IdDevMode)

CloseHandle(overlapped.hEvent);

Referring to FIG. 6, the event synchronization mechanism described above applies for communication between the driver to the command interface. However since a command user interface (CUI) 600 to the command (COM) interface 601 only flows downward, there will need to be a solution to allow the COM unit 601 to signal a change back to the command user interface 600. If the COM layer is used to initiate the hot-key through a mode change to the display driver, this action will be received by the CUI, if still resident as a display change instruction. The CUI can capture changes in the display configuration, for example by saving it to a registry. This allows a user to configure the display change through the command user interface. The other blocks 602-605 function equivalently as earlier described in reference to like identified items. It is appreciated that a variety of other schemes may be readily implemented to provide the driver-based switching schemes.

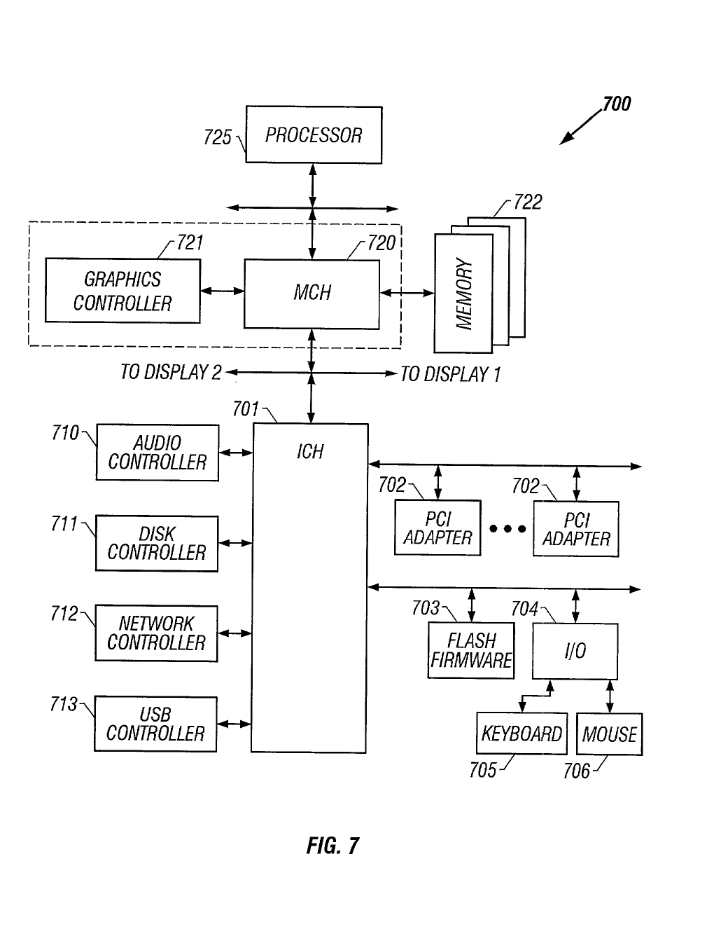

Referring to FIG. 7, a system block diagram 700 illustrates a computer system implementing an embodiment of the driver-based display switching technique. In the example of FIG. 7, an Input/Output Control Hub (ICH) 701 couples to a variety of input/output (I/O) devices, as well as to one or more busses. In the particular example, the ICH unit 701 couples a PCI bus having a plurality of PCI adapters 702. Furthermore the ICH unit 701 couples to other units. Some examples are noted on FIG. 7 as flash memory firmware 703, I/O or keyboard controller 704 (which is shown coupled to a keyboard 705 and mouse 706), audio controller 710, disk controller 711, network controller 712 and universal serial bus (USB) controller 713. It is to be noted that other components may be included or that some of the shown components excluded in other systems.

The ICH 701 is shown coupled to a Memory Control Hub (MCH) 720. The MCH 720 is also coupled to a processor 725 (which may be comprised of a plurality of processors, instead of only one), graphics controller 721 and to memory 722. Also shown is a coupling of the MCH 720 to display units #1 and #2. It is appreciated that the display driver is typically held in memory 722 and operates with the graphics controller 721 in the manners described above to control switching from one of the display units to the other. The hot-key event is typically created by one of a set of fixed key sequences. These sequences involve special combinations of keys, and/or special-sequence of key depresses at keyboard 705. When interpreted by the keyboard controller 704 or other embedded controller, the event is signaled to the ICH 701 and from there to the MCH 720.

It is to be appreciated that the hot-key event handling technique described herein can be adapted for a variety of I/O initiated entry to provide device switching in which the switching is controlled by the device driver instead of the BIOS or other similarly situated routines which places a system into a management mode. Other examples such as selection of display Panel Fitting vs. Centering, and Display Brightness Control may be initiated by a System Hot-Key but completed by the Display Device Driver to the benefit of both. Furthermore, although the examples described pertain to display switching, the application of the invention need not be limited to displays only. For example audio device volume setting can be switched utilizing a hot-key in which the audio driver controls the switching of the audio device. Other examples can be developed which are within the spirit and scope of the described technique.

In reference to the hot-key method for display switching, the technique allows the display switching to be performed outside of the system management mode. The SMM is typically a highly restricted mode of operation. Given that firmware has limitations on its size and complexity, driver-based display switching allows driver-level intelligence to enact the correct technique to perform the display switch, in which full knowledge of the constraints, combination and uses of the display subsystem is known. Furthermore, since the driver is an easily upgradeable component, the technique allows simplified distribution of fixes to problems. The system responsiveness improves due to less time being spent in the SMM and more time is spent in the O/S native pre-emptive context. Accordingly, the embodiments described utilize an interrupt scheme to identify the occurrence of the hot-key event and flags/semaphores are used to control the ownership of the display switching activity by the driver. In essence, an embodiment of the invention permits a device driver to obtain and retain control to perform device switching in response to some event, such as the hot-key actuation initiated by a user.

Various other advantages are noted by the practice of the invention. Given that system firmware has limitations on its size and complexity there is limited ability to support complex display systems. The embodiments of the invention described herein do not require significant complexity at the firmware level to implement the invention. Furthermore improvement in the robustness in the system is provided by not attempting to second guess all the uses and requirements of the display and display streams by all of the clients (for example drivers and applications). The technique also improves the responsiveness of the system, particularly with regards to real-time and isochronous streams such as video, since far less time is spent in SMM and more time is spent in the O/S native primitive context. An embodiment of the invention does not need to make additional O/S level application to monitor hot-key events and perform display switching. It can be accomplishing using the same user interface control applications which are already required to allow user interaction with the display subsystems.

Accordingly, in an embodiment of the invention described, software flags/semaphores are used for controlling the switching. However, other mechanisms may be readily implemented. Also, software triggerable interrupt is used as an event mechanism to initiate driver-based display switching. This allows a variety of operating systems to be utilized and is not limited to relying on certain O/S minimum level functionality. However, other schemes may be used. For example, scratch bits may be used for signaling, instead of interrupts. In one technique, the video BIOS may set bits in a scratch register to communicate status with the display driver and vice versa. A bit is used to indicate to the display driver that a switch has occurred, when the driver reads a register containing the bit. Other examples may be readily obtained.

Thus, method and apparatus for signaling user initiated hot-key action is described. A variety of actions can be initiated. Without limitation, those actions include, display, switching, display panel-fitting or stretching image centering, brightness control, contrast control, backlight control, audio volume control, as well as others.

I claim:

1. An apparatus comprising:
a processor to respond to an event-driven action; and
a driver coupled to said processor to perform a program function when an indication of the event-driven action is received from said processor, said driver to control a response to the event-driven action external to a management mode of said processor.

2. The apparatus of claim 1 wherein said processor responds to an event-driven action from an input/output device.

3. The apparatus of claim 1 wherein said processor responds to an event-driven action from an input/output device to perform a control action on a device.

4. The apparatus of claim 1 wherein said processor responds to an event-driven action from an input/output device to perform a control action on a device which may be simultaneous controlled by system firmware and software device driver.

5. The apparatus of claim 1 wherein said processor responds to a hot-key action to perform a control action operation on a device altering it's current state or setting.

6. The apparatus of claim 1 wherein said processor responds to a hot-key action to perform a control action with the co-operation of both system firmware management and operating system device driver management for the benefit of consistent behavior within an operating system environment.

7. An apparatus comprising:
a controller to receive an indication of an event-driven action from system firmware when the event-driven action occurs and to generate a signal in response to the received indication; and
a device driver coupled to said controller to perform a program function in response to the signal to control an operation to alter the deivees current state, in which the program function performs the control action external to a system management mode of the processor firmware.

8. The apparatus of claim 7 wherein said controller includes an interrupt generation logic to generate an interrupt as the signal in response to a hot-key event-driven action.

9. The apparatus of claim 8 wherein said driver includes an interrupt service routine to process the interrupt and acquire control to perform the control action.

10. The apparatus of claim 9 wherein said driver sets a first flag to acquire control of said controller to perform the control action.

11. The apparatus of claim 10 wherein said driver sets a second flag to indicate to said controller that the control action is completed.

12. The apparatus of claim 11 wherein said controller is interrogated periodically to determine if the second flag is set and if the second flag is set, completing the hot-key event-driven action.

13. The apparatus of claim 7 wherein said controller is a graphics controller with a multiplicity of displays outputs, in which the hot-key event-driven action initiates a display switch from one of the displays to another display.

14. The apparatus of claim 7 wherein said controller also includes a basic input output system, BIOS, programming to allow the management mode of the firmware to control the switching and in which a programmed selection determines if said driver or the BIOS programming controls the switch.

15. The apparatus of claim 7 wherein said controller is a graphics controller and includes a video basic input output system, BIOS, programming to allow the management mode of the firmware to control the switching and in which a programmed selection determines if said driver or the video BIOS programming controls the switch between a first and second display devices.

16. A driver comprising:
a first routine to receive a signal in response to an indication of an event-driven action from a processor firmware when the event-driven action occurs; and
a second routine to control an operation to switch a program function from supporting a first device to support a second device, in which the driver's program function performs the switch external to a management mode of the processor firmware.

17. The driver of claim 16 wherein the driver supports a variety of input/output, I/O, devices and the driver performs the control action on the devices.

18. The driver of claim 16 wherein the driver supports a variety of display devices and the driver performs the switch from a first display device to any other display device.

19. The driver of claim 18 wherein the first routine receives an interrupt in response to the indication of an event-driven action from a processor firmware and generates a flag to obtain control from a controller for the display switch.

20. A machine-readable medium that provides instructions, which when executed by a machine, causes the machine to perform operations comprising:
processing a signal in response to an indication of an event-driven action from a processor firmware when the event-driven action occurs; and
performing a routine to control an operation to switch a program function from supporting a first device to support a second device, in which the routine performs the switch external to a management mode of the processor firmware.

21. The machine-readable medium of claim 20 further including an instruction to set a flag to a controller to indicate that the routine is prepared to perform the switch.

22. The machine-readable medium of claim 20 further including an instruction to set a flag to a controller to indicate that the routine has completed the switch.

23. A method comprising:
generating an indication of an event-driven action to perform some action on a device;
responding to the indication to handle the event-driven action external to a system management mode of system firmware;
handling the device switch external to the management mode of a processor firmware by having a driver handle the control action; and
returning control from the driver at completion of the device switch.

24. The method of claim 23 wherein the handling of the device switch by the driver includes switching from one display device to another display device.

25. The method of claim 23 wherein the handling of the display image fitting or image centering by the driver includes adjusting a device setting.

26. The method of claim 23 wherein the handling of the display brightness by the driver includes adjusting the brightness of the display.

27. The method of claim 23 wherein handling of the device control is in response to receiving an interrupt, upon which the driver performs the control action.

28. A computer system comprising:
a system firmware including a basic input output system, BIOS, programming to detect an event-driven action;
a controller to receive an indication from said processor firmware of an event-driven action when the event-driven action occurs and to generate a signal in response to the received indication; and
a driver coupled to said controller to perform a program function in response to the signal to control an operation to control aspects of the device, in which the program function performs the operation external to system management mode of said processor firmware.

29. The computer system of claim 28 wherein said controller is a graphics controller and a switching action is initiated between a plurality of attached display devices.

30. The computer system of claim 28 wherein the event-driven action is a hot-key action.
